(19) United States
(12) Patent Application Publication
(10) Pub. No.: US 2007/0201219 A1
(43) Pub. Date: Aug. 30, 2007

(54) HIGH VISIBILITY SAFETY SIGN

(75) Inventor: Aaron Golle, Shakopee, MN (US)

Correspondence Address: SCHWEGMAN, LUNDBERG, WOESSNER & KLUTH, P.A., P.O. BOX 2938, MINNEAPOLIS, MN, 55402, US

(73) Assignee: Safe Lites, LLC

(21) Appl. No.: 11/674,993

(22) Filed: Feb. 14, 2007

Related U.S. Application Data
(60) Provisional application No. 60/743,293, filed on Feb. 14, 2006.

(51) Int. Cl. F21V 9/16

(52) U.S. Cl. 362/84

(57) ABSTRACT

A safety sign for school and other buses and methods are shown with advantages such as being more visible in poor conditions such as snow, dust, fog, low light, etc. Safety signs as shown can be seen from farther away than conventional signs.

### RELATED APPLICATIONS

This patent application claims the benefit of priority, under 35 U.S.C. Section 119(e), to U.S. Provisional Patent Application Ser. No. 60/743,293, filed on Feb. 14, 2006, which is incorporated herein by reference.

### TECHNICAL FIELD

This invention relates to safety equipment. Specifically, this invention relates to safety signs that exhibit high visibility.

### BACKGROUND

Every day of the school year millions of school children are transported to and from school in school buses. The visibility of these buses is extremely important not only to protect the buses from collision, but also to alert drivers to the potential presence of school children getting on and off the bus. Despite the best efforts of safety officials, an unacceptable number of school bus accidents continue to occur each year. As a result, any technology that offers a cost-effective way to improve school bus safety is of paramount importance to the public good.

### SUMMARY

The inventive subject matter includes system and method for providing an electroluminescent sign for a bumper for a school bus or other buses.

### BRIEF DESCRIPTION OF THE DRAWINGS

FIG. 1 shows a cross section diagram of a safety sign according to an embodiment of the invention.

FIG. 2 shows an isometric view of a safety sign according to an embodiment of the invention.

FIG. 3 shows an isometric view of a safety sign according to an embodiment of the invention.

FIG. 4 shows a front view of a safety sign according to an embodiment of the invention.

FIG. 5 shows an isometric view of a safety sign according to an embodiment of the invention.

FIG. 6 shows a front view of a safety sign according to an embodiment of the invention.

FIG. 7 shows a diagram of one embodiment of a method for plowing a road.

FIG. 8 shows a diagram of one embodiment of a method for transporting an oversized load.

FIG. 9 shows a print for an embodiment of a safety sign according to an embodiment of the invention.

FIG. 10 shows specifications for an embodiment of a safety sign according to an embodiment of the invention.

FIGS. 11A and 11B show an EL sign assembly on a school bus bumper according to one embodiment of the inventive subject matter.

FIG. 12 and FIG. 13 illustrate a perspective and rear views of an EL sign assembly according to an embodiment of the inventive subject matter.

FIG. 14-FIG. 20 show various views of an EL sign assembly according to various embodiments of the inventive subject matter.

### DETAILED DESCRIPTION

In the following detailed description, reference is made to the accompanying drawings which form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, electrical changes, etc. may be made without departing from the scope of the present invention.

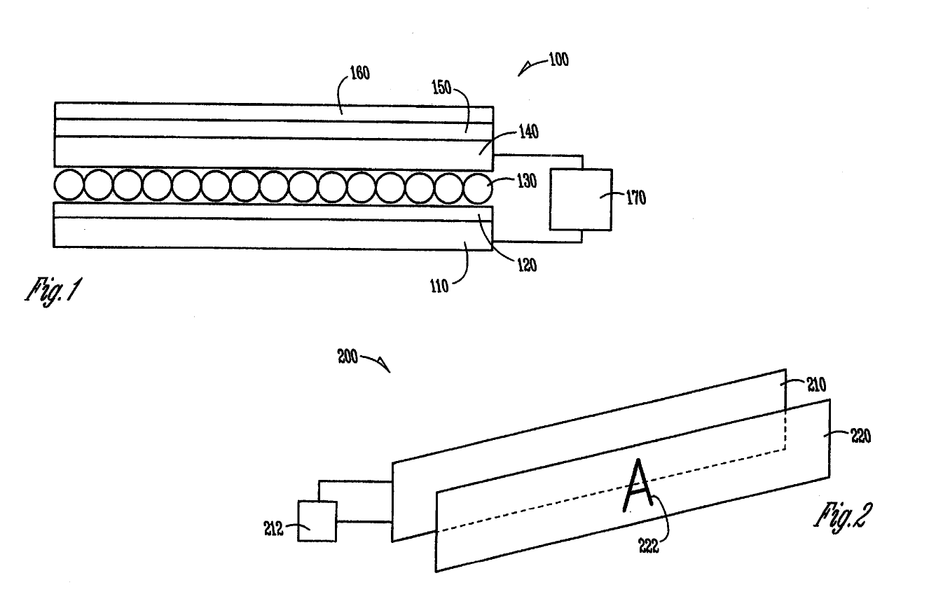

FIG. 1 shows a safety sign 100 utilizing electroluminescent (EL) technology. A conducting base 110 is shown with a dielectric layer 120 coupled to the conducting base 110. The base is for some embodiments rigid and for other embodiments flexible. This feature enables the sign to be positioned on rigid or flexible surfaces. A number of encapsulated phosphor portions 130 are shown coupled to the dielectric layer 120. In one embodiment, the number of encapsulated phosphor portions 130 are microencapsulated. A second conducting portion 140 is shown coupled over the number of encapsulated phosphor portions 130. In one embodiment, the second conducting portion 140 includes a transparent conductor material. In one embodiment, an encapsulating layer 150 is included over the second conducting portion 140. In one embodiment, the encapsulating layer 150 is included to provide moisture or weather resistance. A pattern layer 160 is further shown coupled over the encapsulating layer 150. In one embodiment, the pattern layer 160 defines a message or symbol that indicates safety or caution.

One of ordinary skill in the art, having the benefit of the present specification will recognize that alternative designs of an EL lighting device are possible. FIG. 1 is intended to illustrate one possible embodiment of an EL lighting configuration in a safety sign. One good example of EL lighting can be obtained from the Durel corporation of Chandler, Ariz.

FIG. 2 shows an embodiment of a safety sign 200. The safety sign 200 includes an EL lighting surface 210, and a power source 212 coupled to the EL lighting surface 210. In one embodiment, the power source 212 includes an AC power source. In one embodiment, the power source 212 includes a DC power source coupled to an AC converter. In one embodiment, the power source is supplied by a power hook up on a vehicle. A layer 220 is also included, with a pattern 222 located on the layer 220. In FIG. 2, the layer 220 includes a transparent layer. The pattern 222 in FIG. 2 is substantially opaque. Embodiments of patterns 222 include, but are not limited to, text, numbers, symbols, shapes, etc. The safety sign 200 operates by transmitting light from the EL lighting surface 210 through portions of the layer 220 that are not obscured by the pattern 222. As used herein, the term “vehicle” refers to two-wheeled, three-wheeled and four-wheeled automobiles, trucks, semi's, fire engines, trains, rail cars, snowplows, bicycles, police cars, buses, ambulances, and any other vehicle having safety needs.

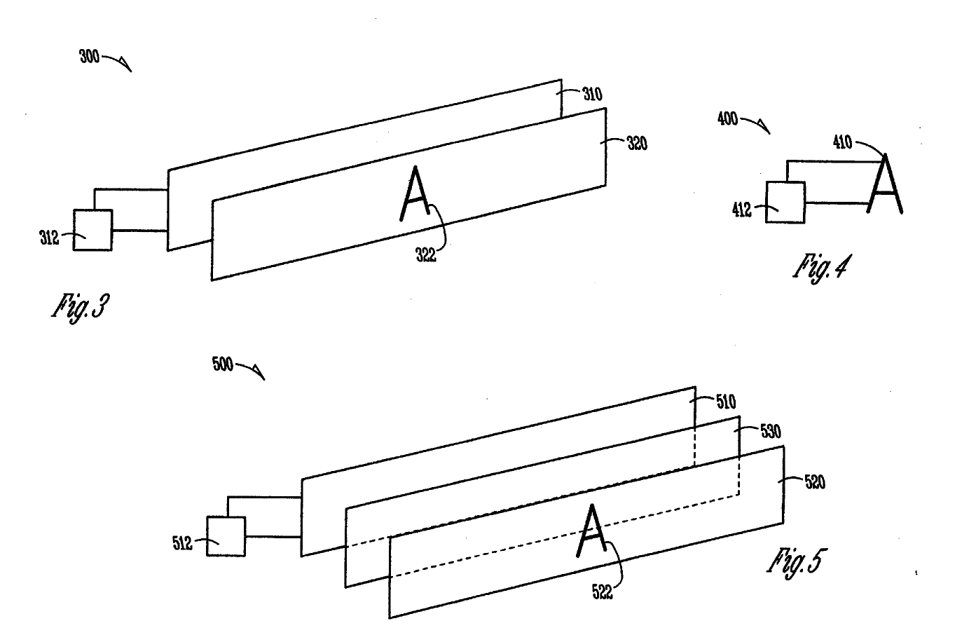

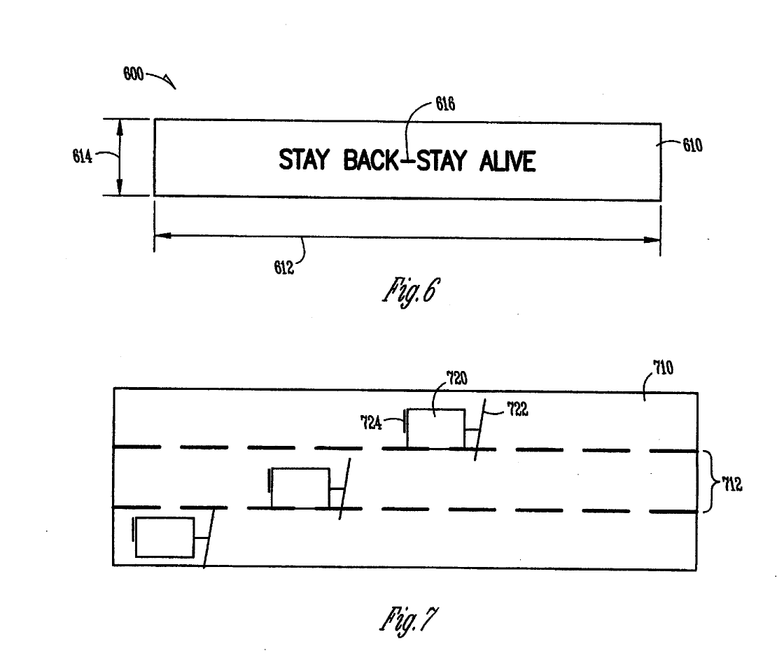

FIG. 3 shows an embodiment of a safety sign 300. The safety sign 300 includes an EL lighting surface 310, and a power source 312 coupled to the EL lighting surface 210. Power source 312 includes, but is not limited to embodiments of power sources described above. A layer 320 is also included, with a pattern 322 located on the layer 320. In FIG. 3, the layer 320 includes a substantially opaque layer. The pattern 322 in FIG. 3 is substantially transparent. In one embodiment, the pattern 322 is cut out from the layer 320. Pattern 322 includes, but is not limited to embodiments of patterns described above. The safety sign 300 operates by transmitting light from the EL lighting surface 310 through the substantially transparent pattern 322.

FIG. 4 shows an embodiment of a safety sign 400. The safety sign 400 includes an EL lighting surface 410, and a power source 412 coupled to the EL lighting surface 410. Power source 412 includes, but is not limited to embodiments of power sources described above. In one embodiment, the EL lighting surface 410 is shaped into a pattern. The pattern includes, but is not limited to embodiments of patterns described above. The safety sign 400 operates by transmitting light from the EL lighting surface 410 directly in a pattern that conveys a message of safety. A text pattern may, for example, convey a warning. A triangle or other geometric shape may indicate a slow moving vehicle, etc.

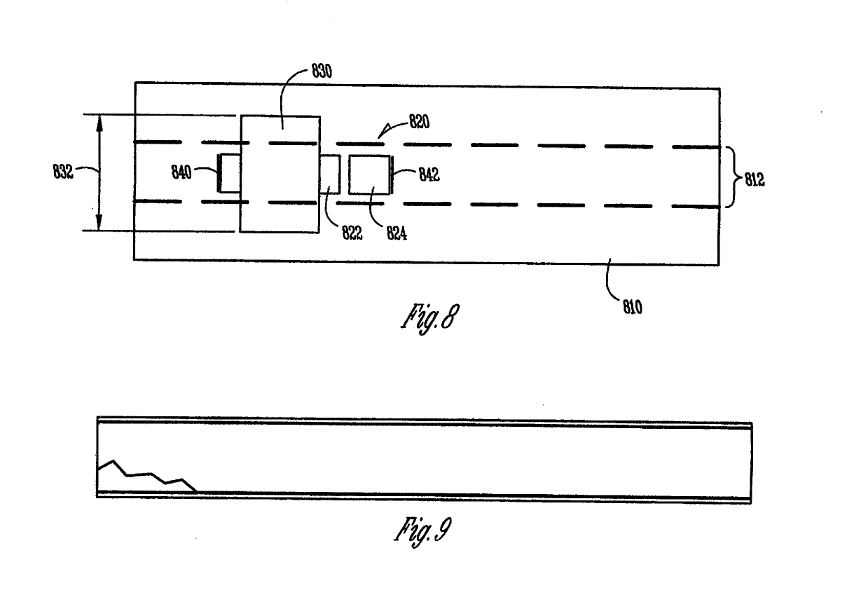

FIG. 5 shows an embodiment of a safety sign 500. The safety sign 500 includes an EL lighting surface 510, and a power source 512 coupled to the EL lighting surface 510. Power source 512 includes, but is not limited to embodiments of power sources described above. A layer 520 is also included, with a pattern 522 located on the layer 520. In FIG. 5, the layer 520 includes a transparent layer. The pattern 522 in FIG. 2 is substantially opaque. Alternatively, the layer 520 in FIG. 5 may include a substantially opaque layer with a pattern 522 that is substantially transparent. A layer 530 is further included in the safety sign 500. The layer 530 includes properties that alter a color of the EL lighting surface 510.

Selected embodiments of safety signs as described in this document include colored EL material. Both an illuminated color and a non-illuminated color may be selected. Possible colors include yellow, white, blue-green, etc. A color can be chosen in the non-illuminated condition that is suited for daytime, while a different color can be chosen for the illuminated condition to optimize both day and night. The addition in safety sign 500 of a layer 530 further broadens color options. In one embodiment, the layer 530 is tinted to alter the color of the EL lighting surface. In one embodiment, an EL lighting surface is included that is white in a non-illuminated condition, and blue-green in an illuminated condition. In one embodiment, a yellow tinted layer 530 is further included. This provides a yellow appearance in the day, with a light green appearance at night. In one embodiment, the light green complies with government regulations for color. In another embodiment, an EL lighting surface is included that is yellow in a non-illuminated condition, and yellow in an illuminated condition. In one embodiment, a yellow tinted layer 530 is further included. This provides a yellow appearance in the day, and a yellow appearance at night.

In one embodiment, the pattern 522 is cut out from the layer 520. Pattern 522 includes, but is not limited to embodiments of patterns described above. The safety sign 500 operates by transmitting light from the EL lighting surface 510 through the layer 530 and through substantially transparent portions of the layer 520.

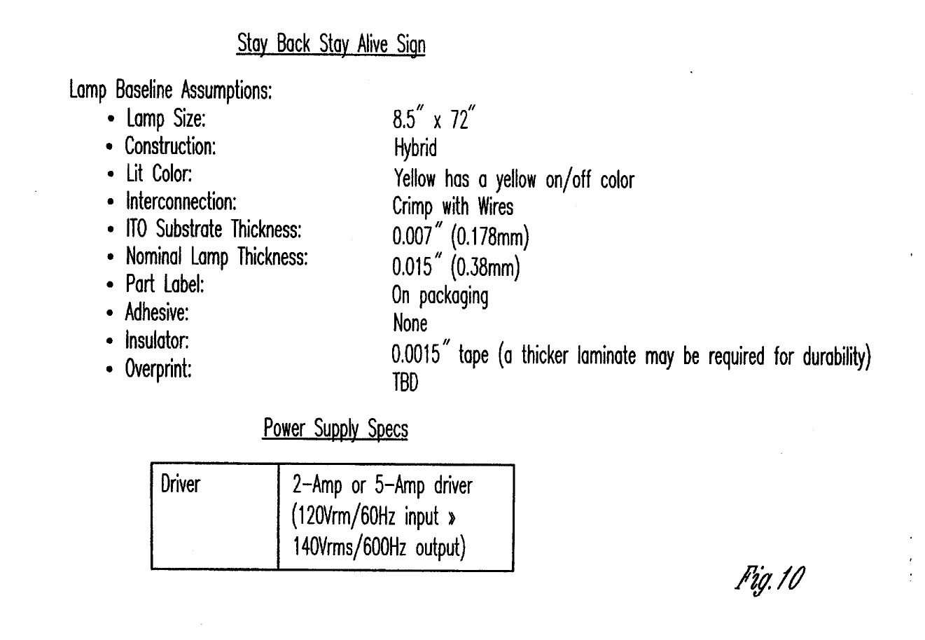

FIG. 6 shows one embodiment of a safety sign 600. The safety sign 600 includes an EL lighting surface 610. In one embodiment the shape of the safety sign 600 is dictated by a government standard. In FIG. 6, the EL lighting surface 610 of the safety sign 600 is substantially rectangular in shape. In FIG. 6, a width 612 of the EL lighting surface 610 is approximately 72 inches. In FIG. 6, a height 614 of the EL lighting surface 610 is approximately 8.5 inches. A pattern 616 is included on the safety sing 600 similar to embodiments described above. In one embodiment the pattern includes a text message that states “Stay Back—Stay Alive.” In one embodiment the pattern includes a text message that states “Oversized Load.” Any number of safety messages are possible within the scope of the invention. In addition to text, as described above, shapes or symbols are also possible to convey a message of safety. For example, a triangle may be used to indicate a slow moving vehicle.

FIG. 7 shows an embodiment of a method utilizing safety signs as described in embodiments above. A road 710 is shown with a number of lanes 712. A number of vehicles 720 are shown on the road in a formation. In one embodiment, the vehicles 720 include snow plows. Other embodiments of vehicles include, but are not limited to, road graders, dump trucks, various construction equipment, road transportation vehicles, flat bed trucks, etc. The vehicles 720 as shown in FIG. 7 are snow plows, each vehicle 720 including a plow 722. In one embodiment, a safety sign 724 as described in embodiments above is affixed to at least one vehicle 720. In one embodiment, the vehicles 720 guide off each other in alignment using the safety signs 724. In one embodiment, the safety signs 724 are affixed to the rear of the vehicles 720. In one embodiment, the safety signs 724 are affixed to the front of the vehicles 720. One of ordinary skill in the art, having the benefit of the present specification will appreciate that several possible formations of vehicles are possible within the scope of the invention.

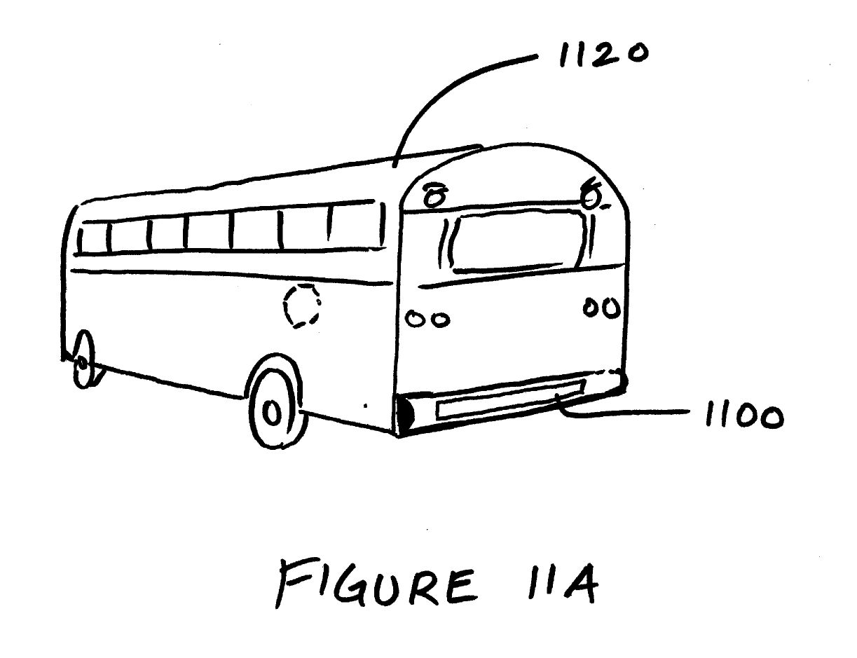

FIG. 8 shows an embodiment of a method utilizing safety signs as described in embodiments above. A road 810 is shown with a number of lanes 812. A transportation vehicle 820 such as a flat bed truck is shown with a payload portion 822 and a cab portion 824. A load 830 is shown as an oversized load with a width 832 that affects more than one lane 812. A safety sign 840 according to embodiments described above is shown attached to a rear portion of the transportation vehicle 820. In one embodiment, an additional safety sign 842 according to embodiments described above is shown attached to a front portion of the transportation vehicle 820.

For some embodiments, vehicles include more than one safety sign using EL lighting. The signs are positionable on the front and rear and side portions of a vehicle. In one embodiment, safety signs and other indicia illuminated by EL lighting are positionable on mud flaps. Mud flaps, as used herein, are a component of a vehicle.

FIG. 9 shows a print of a safety sign according to one embodiment of the invention. FIG. 10 shows operational specifications according to one embodiment of the invention.

Safety signs as described above all utilize EL technology. EL technology provides a number of advantages to safety signs as described above. The safety signs described using EL technology use lower power than conventional lighting technology. The safety signs described using EL technology produce very low heat compared to conventional lighting technology. This can be especially advantageous in snow applications as discussed above in the background. The safety signs described using EL technology are more robust than conventional lighting technology, and not prone to catastrophic failure. Due to numerous encapsulated phosphor portions, it is difficult to damage all encapsulated phosphor portions during an event such as a rock hitting a sign. Further, EL lighting does not burn out catastrophically as incandescent light bulbs do.

Further, because EL lighting generates light from encapsulated portions along a large area (such as 72 inches by 8.5 inches) the light provided by the EL lighting is not a point source, but is an area source. This reduces or eliminates night blinding, and flicker produced by point sources such as incandescent lights, and LEDs. Further, the area source of EL lighting can be seen from farther away, and through difficult conditions such as snow, dust, fog, etc. This is due to EL lighting providing numerous sources (an area of sources) of light to compensate for scattering and dispersement of light from any one individual source in the EL surface.

For the reasons above, safety signs as described above are more visible in poor conditions such as snow, dust, fog, low light, etc. Safety signs as described above can be seen from farther away than conventional signs. Safety signs as described above eliminate problems associated with point source lighting.

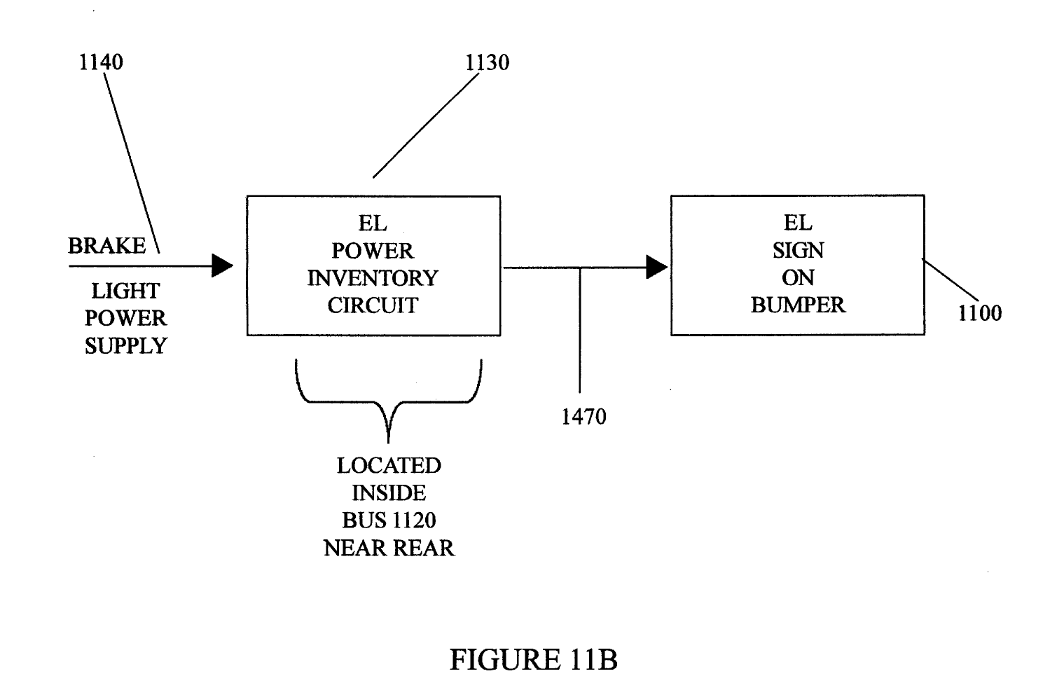

Referring now to FIG. 11A, there is illustrated an EL sign assembly 1100 on a school bus bumper 1110 of a school bus 1120 according to one embodiment of the inventive subject matter. As illustrated in the schematic diagram of FIG. 11B, assembly 1100 is powered, in one example embodiment, from an AC inverter 1130 that is supplied from a DC power source such as, in one embodiment, the brake light power supply 1140 of the bus 1120. In operation, when the bus's brakes are applied, brake light power supply 1140 provides power to illuminate the bus's brakes lights, and in addition supplies power to the AC inverter 1130, which in turn activates the EL lamps in assembly 1100, causing the sign to glow, in one example embodiment, red. In another example embodiment, power for the EL sign assembly 1100 may come from an alternate source and provide for always-on operation or for activation in unison with the brake lights of the bus.

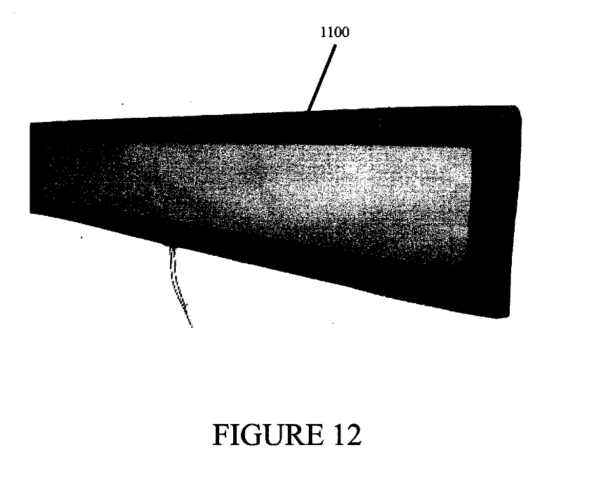

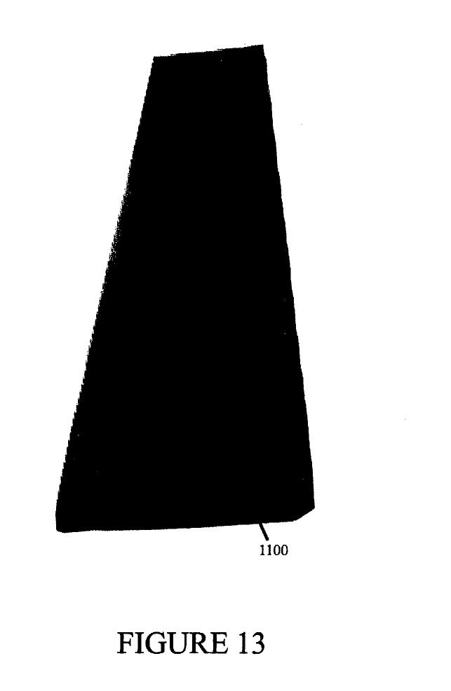

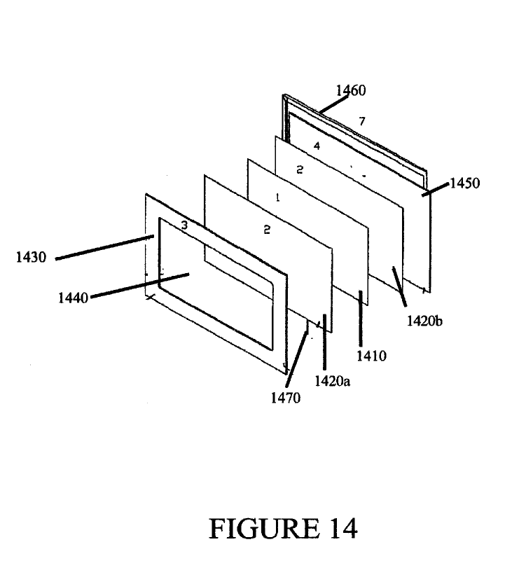

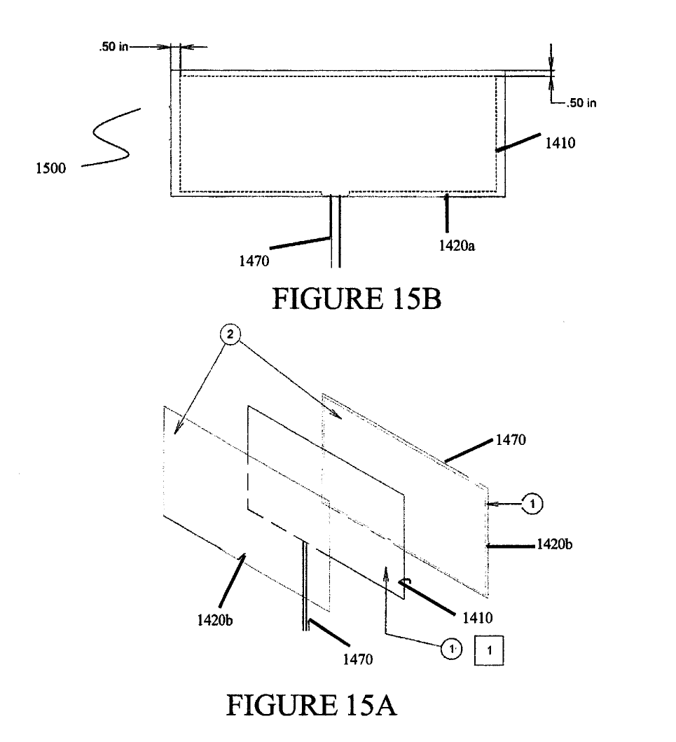

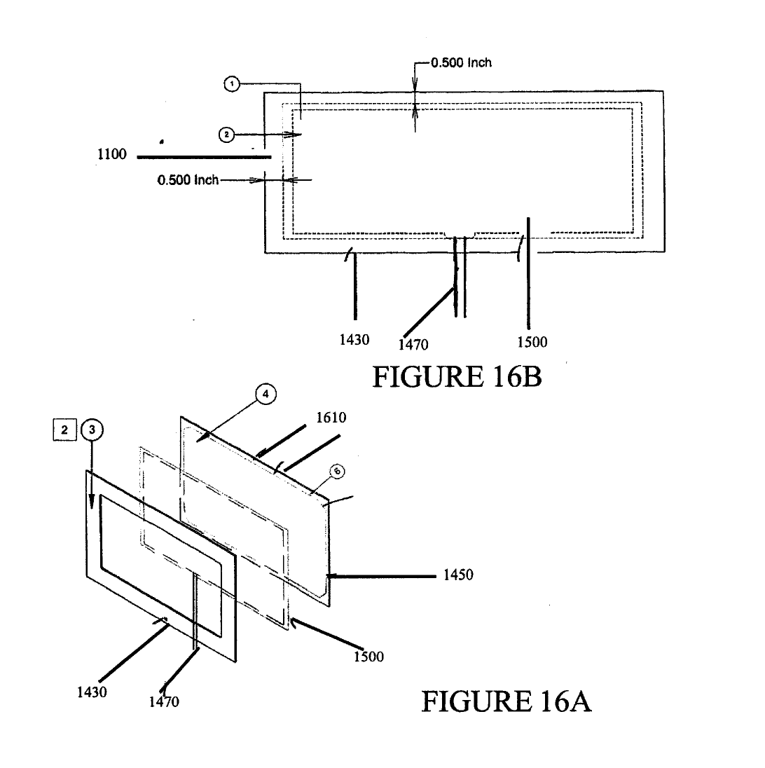

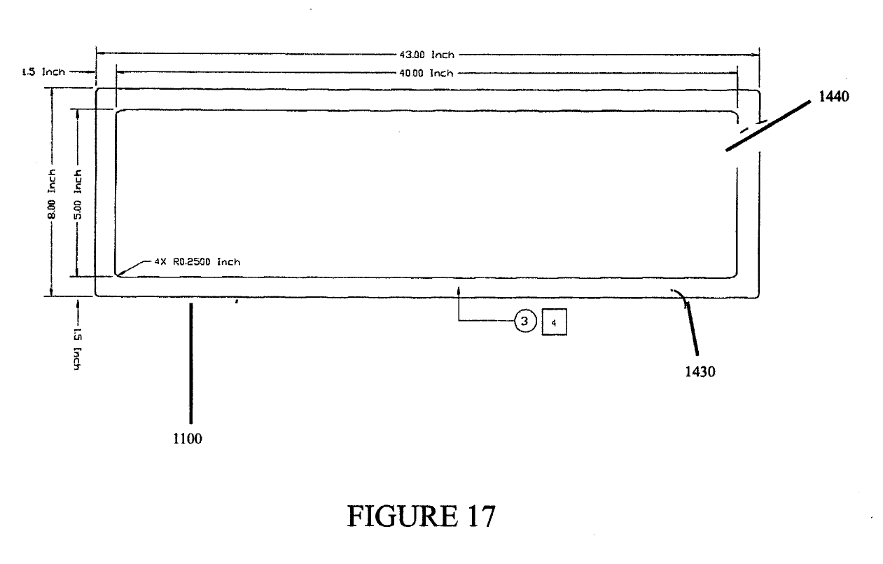

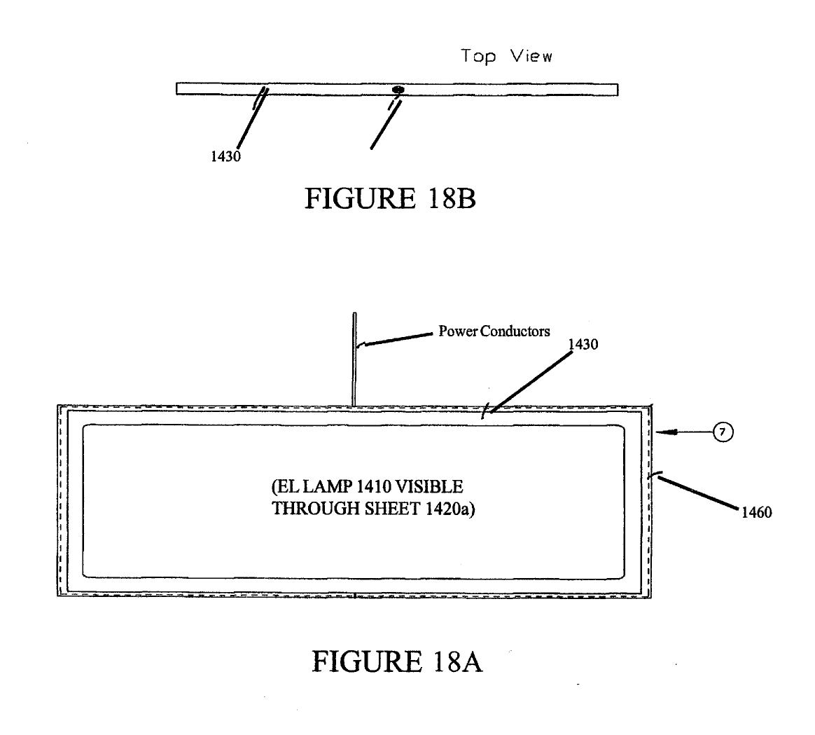

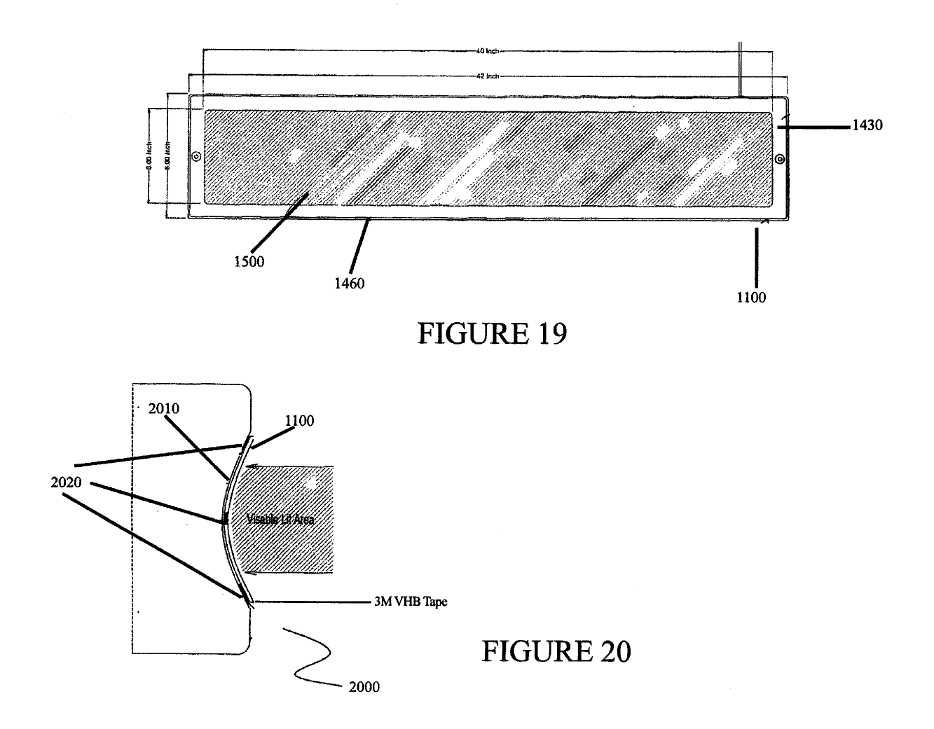

FIG. 12 and FIG. 13 illustrate a perspective and rear views of the EL sign assembly 1100, respectively, according to an embodiment of the inventive subject matter. FIG. 14-FIG. 20 show various views of the various components of the EL sign assembly 1100 according to various embodiments of the inventive subject matter. As shown in FIG. 14, assembly 1100 includes an EL lamp assembly 1410, transparent UV-protected polycarbonate sheets 1420a and 1420b (about 7 inches in height and 42 inches in width, and about 0.010 inches in thickness), a front rubber sheet 1430 with an aperture 1440, a rear rubber sheet 1450, and a rear flexible trim member 1460. According to one example embodiment, the rubber sheets 1430 and 1450 are made of ET-121 rubber with Levant finish. A pair of conductors 1470 provide power to the lamp assembly 1410. Referring to FIG. 15A and FIG. 15B, assembly 1100, according to one example embodiment, is assembled by first applying a silicon modified polymer sealant at a width, for example only, of about 0.5″ wide around the periphery 1470 of at least one of the sheets 1420a and 1420b, and then pressing them together, in order to seal EL lamp assembly 1410 inside an envelope assembly 1500 formed by the sheets 1420a and 1420b. As shown in FIG. 15B, the outer dimension of the EL lamp assembly 1410 is smaller than the outer dimension of the sheets 1420a and 1420b. Next, as shown in FIG. 16A and FIG. 16B the sealed EL lamp assembly 1500 is positioned between the back rubber sheet 1450 and the front rubber sheet 1430. The sides of the rubber sheets 1430 and 1450 facing inwardly toward the assembly 1500 are lined with an adhesive such as, but not by way of limitation, Avery Dennison 3081-53 heat activated acrylic adhesive with 100# Supertuff release liner, which can be heat activated to seal the inward facing surface of the rubber sheet 1450 to the back sheet of assembly 1500 and the other rubber sheet 1430 along the periphery, and the inward facing surface of rubber sheet 1430 to the front sheet of assembly 1500. To provide additional sealing, a polymer adhesive 1610 may also be applied to one or both of the rubber sheets 1430 and 1450, at a width, for example only, of about 0.5″, to provide additional sealing to supplement any sealing achieved with the heat activated acrylic adhesive. In addition, the assembly 110 may optionally include trim piece 1460. Referring to FIG. 17, according to one example embodiment, the EL sign assembly is about 43 inches in width and about 8 inches in height. The aperture on the front exposing the EL lamps through the transparent polycarbonate sheet 1420, is, in one example embodiment but not by way of limitation, about 5 inches in height and 40 inches in width. Thus, in one example embodiment, the visible lit area of the EL sign assembly 1100 is about 5 inches by 40 inches. In addition, according to another example embodiment, the lit EL area is red in color, such that the EL sign assembly 1100 provides additional visibility of a brake light indication for the bus. However, other colors are also possible, such as yellow or white or other colors. The completed assembly, with trim piece 1460 around the edges, is shown in FIG. 18A and FIG. 18B and FIG. 19.

Further, as shown in FIG. 20, there is illustrated one example embodiment of mounting the EL sign assembly 1100 to a bumper 2000 that includes a concave portion 2010, wherein the EL sign assembly 1100 is flexed to generally conform to the contours of the concave portion and fastened to the bumper using VHB tape 2020 available from the 3M Company of St. Paul, Minn. According to another example embodiment not shown, EL sign assembly 1100 may be mounted to a bumper with a generally flat profile, or other curved profiles. As noted above with respect to FIG. 11B, the power inverter 1130 is located inside the bus in the rear and fed with the brake light power for the bus. The conductors 1470 supplying power to the EL lamp assembly 1410 are fed through the back of the bus to the power from inverter 1130.

According to another example embodiment, the EL sign assembly 1100 may be rigid as opposed to flexible, and further may be mounted on the back of a bus other than on the bumper, for example above the bumper below the back windows, or above the back windows just below the roof line of the bus.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. It is to be understood that the above description is intended to be illustrative, and not restrictive. Combinations of the above embodiments, and other embodiments will be apparent to those of skill in the art upon reviewing the above description. The scope of the invention includes any other applications in which the above structures and fabrication methods are used. The scope of the invention should be determined with reference to the appended claims, along with the full scope of equivalents to which such claims are entitled.

What is claimed is:

1. Apparatus, comprising:
a school bus having a rear bumper; and
a flexible EL lighting assembly fastened to the rear bumper wherein the EL lighting assembly includes an EL lamp area viewable to vehicles at the rear of the bus; and
wherein the EL lighting assembly is powered by a brake light power line for the bus.

2. A method, comprising:
forming a flexible EL lighting assembly by sealing an EL lamp assembly within an envelop formed from at least two sheets of transparent and impermeable material, and further sandwiching the envelope between a rubber back portion and a rubber front portion, wherein the rubber front portion includes an aperture through which light emitted from the EL lamp assembly may pass.
